(19) United States
(12) Patent Application Publication
(10) Pub. No.: US 2012/0317702 A1
(43) Pub. Date: Dec. 20, 2012

(54) Slidably Adjustable Magnetic Catch for Garment

(75) Inventors: Dixie M. Daly, Loveland, CO (US); Cynthia J. Hart, Fort Collins, CO (US)

(73) Assignee: Sassy Blitz, LLC

(21) Appl. No.: 13/492,674

(22) Filed: Jun. 8, 2012

Related U.S. Application Data
(60) Provisional application No. 61/520,899, filed on Jun. 15, 2011.

(51) Int. Cl. A41F 1/00; B23P 17/04

(52) U.S. Cl. 2/265; 29/428

(57) ABSTRACT

A magnetic catch for a garment having which allows adjustment of the garment proximate a magnetically coupled first catch part and a second catch part without release of the magnetic catch.

This United States Non-Provisional patent application claims the benefit of U.S. Provisional Patent Application No. 61/520,899, filed Jun. 15, 2011, hereby incorporated by reference herein.

### I. FIELD OF THE INVENTION

A magnetic catch for a garment which allows adjustment of the garment proximate a magnetically coupled first catch part and a second catch part without release of the magnetic catch.

### II. BACKGROUND OF THE INVENTION

Conventional catches for garments having releasable mated parts such as snaps, hooks, hook and loop, and the like require release of the mated parts such as release of a hook from a loop to adjust the garment in relation to itself or the wearer and further manipulation of the catch to mate the parts of the catch. There would be an advantage in a catch that allows adjustment of the garment in relation to itself or the wearer without having to release the mated parts of the catch.

The instant invention provides a magnetic catch for slidably adjusting a garment which overcomes in whole or in part certain disadvantages of conventional garment catches.

### III. SUMMARY OF THE INVENTION

Accordingly, a broad object of the invention can be to provide a catch which without releasing the mated parts thereof allows a garment to be adjusted in relation to itself or the wearer.

Another substantial object of the invention can be to provide a method of adjusting a garment without unfastening the mated parts of a catch.

Naturally, further objects of the invention are disclosed throughout other areas of the specification, drawings, photographs, and claims.

### IV. BRIEF DESCRIPTION OF THE DRAWINGS

FIG. 1 is an illustration of a method of using an embodiment the inventive magnetic catch for a garment.

FIG. 2 is a plan view of an embodiment of the slidably adjustable magnetic catch included in the garment shown in FIG. 1.

FIG. 3 is a side view of a particular embodiment of the slidably adjustable magnetic catch included in the garment shown in FIG. 1.

FIG. 4 is cross section 4-4 shown in FIG. 2 which provides an enlarged view of a portion of the slidably adjustable magnetic catch included in the garment shown in FIG. 1.

### V. DETAILED DESCRIPTION OF THE INVENTION

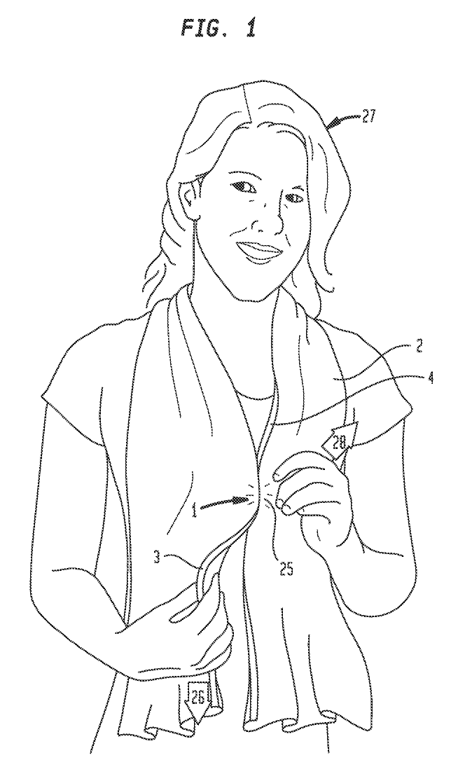

Now referring primarily to FIGS. 1-4, embodiments of the invention include a magnetic catch (1) which can be utilized on any of a wide variety of garments (2). While FIG. 1 provides an illustrative example of using a particular embodiment of the magnetic catch (1) in association with a generally flat rectangular garment (2) such as a scarf or a shawl, the invention is not so limited, and the garment (2) can be any garment (2) having a pair of surfaces (3) (4) which can be disposed in opposed relation to couple a first catch part (29) and a second catch part (30) of the magnetic catch (1) as further described below such as shirts, robes, towels, wrist bands, ankle bands, head bands, or other garments (2) which can be disposed about the wrist, neck, waist, arm, leg, ankle, or the like. Any particular garment (2) can further include one or more pouches (5) which can be of generic configuration or can be specifically configured to retain a cellular telephone, credit card, identification card, wallet, or the like.

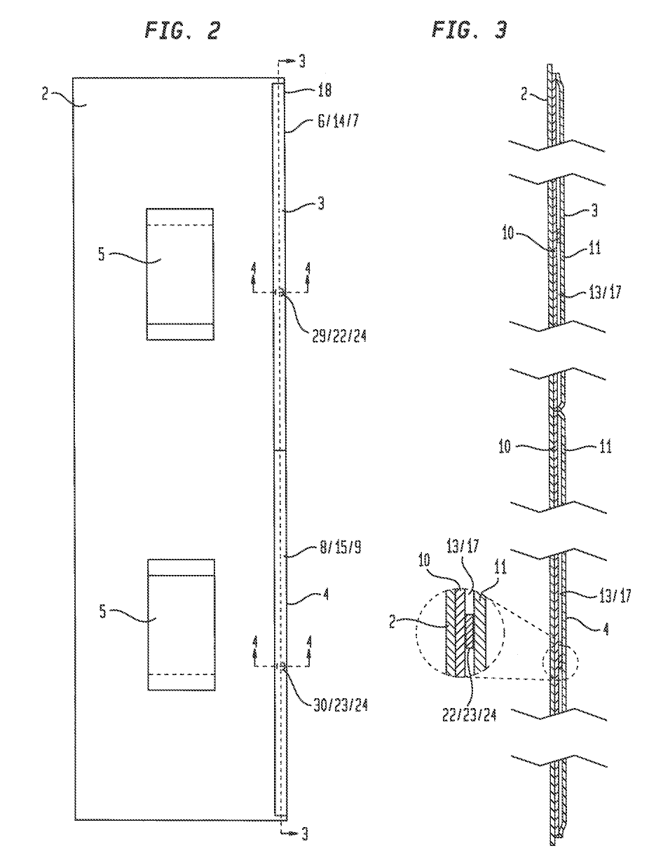

Now referring primarily to FIGS. 2 through 4, particular embodiments of magnetic catch (1) can include a first pocket (6) coupled at a first location (7) on a garment (2). The magnetic catch (1) can have magnetically coupled first and second catch parts (29)(30) with the first catch part (29) enclosed inside of the first pocket (6). The second catch part (30) can coupled at a second location (9) on the garment (2). The first location (7) and the second location (9) on the garment (2) allows magnetic coupling of the first catch part (29) and the second catch part (30). The first catch part (29) can slide within the first pocket (6) to allow movement of the first pocket (6) in relation to the second catch part (30) without magnetically uncoupling the first catch part (29) from the second catch part (30), thereby allowing adjustment of the garment (2).

Again referring primarily to FIGS. 2 through 4, particular embodiments of the slidably adjustable magnetic catch (1) can further include a second pocket (8) coupled at a second location (9) on the garment (2). The second catch part (30) can be enclosed inside of the second pocket (8). The first catch part (29) enclosed inside of the first pocket (6) can be magnetically coupled to the second catch part (30) enclosed inside of the second pocket (8). The first catch part (29) can slide within the first pocket (6) and the second catch part (30) can slide within the second pocket (8) to allow movement of the first pocket (6) and the second pocket (8) in relation to the coupled magnetic catch (1) without magnetically uncoupling the first catch part (29) from the second catch part (30), thereby allowing adjustment of the garment (2).

As to particular embodiments of the magnetic catch (I), the first catch part (29) can be a magnet (22) (also referred to as the first magnet) or a ferromagnetic material (24) and the second catch part (30) can be a magnet (23) (also referred to as the second magnet) or a ferromagnetic material (24). Understandably, at least one of the first magnetic catch part (29) or the second magnetic catch part (30) must be a magnet (22) of sufficient magnetic strength to magnetically couple the corresponding first catch part (29) or second catch part (30) under normal use of the magnetic catch (1) as described herein. The term “magnet” for the purposes of this invention means a piece of iron or other ore, alloy or other material that has its component atoms so ordered to exhibit properties of magnetism. The term “ferromagnetic material” for the purposes of this invention means a piece of iron, or other ore, alloy or other material attracted toward a magnet.

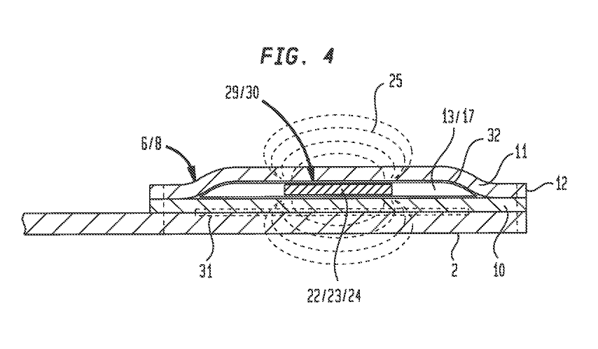

Now referring primarily to FIGS. 1 through 4, as one illustrative example of the inventive magnetic catch (1), a first magnet (22) can be located within the inside space (13) (elongate rectangular inside space (17)) of the first pocket (6) (first elongate pocket (14)) and a second magnet (23) can be located within the inside space (13) (elongate rectangular inside space (17)) of the second pocket (8) (second elongate pocket (15)) (as shown in the example of FIG. 4). As to certain embodiments, the first magnet (22) or the second magnet (23) can have a fixed location within the inside space (13)(17) of a corresponding first pocket (6)(14) or a second pocket (8)(15) while the other one of the first or second magnets (22)(23) can move freely within the corresponding first pocket (6)(14) or second pocket (8)(15). As to other particular embodiments of the invention, both the first magnet (22) and the second magnet (23) can move freely within the corresponding inside space (13)(17) of the first pocket (6)(14) and the second pocket (8)(15). As to certain embodiments, only a first magnet (22) located within the inside space (13) of a first pocket (6) may be provided while a ferromagnetic material (24) can be provided in the inside space (13) of a second pocket (8)(15).

Now referring primarily to FIG. 4, the first magnet (22) and the second magnet (23) (or the ferromagnetic material (24)) can have any configuration suitable for slidable location within the inside space (13) of the corresponding first pocket (6) and second pocket (8). As shown by the examples of FIGS. 2 through 4, the first magnet (22) and the second magnet (23) can take the form of cylinder with a diameter in the range of about one quarter inch and about one half inch and height in the range of about one sixteenth inch and about one eighth inch; however, embodiments of the invention can utilize any configuration of magnet or ferromagnetic material which can be slidably located in a particular configuration of pocket and serve as the first catch part (29) or the second catch part (30) of the magnetic catch (1) to magnetically couple and allow movement of the corresponding pocket without magnetically uncoupling the magnetic catch (1).

Now referring primarily to FIGS. 2 through 4, particular embodiments of the first pocket (6) and the second pocket (8) can be formed from a first layer of material (10) and a second layer of material (11) joined together by stitches, adhesive, heat seal, or the like, to provide a closed perimeter (12) which encloses an inside space (13)(17) between the first layer of material (10) and the second layer of material (11) (as shown in the example of FIG. 4).

The first layer of material (10) and the second layer of material (11) can be any of a numerous and wide variety of materials including but not limited to a woven fabric of naturally or non-naturally occurring fibers such as metal, cotton, nylon, silk, rayon, cellulose, or the like, or can be a non-woven sheet material such as a plastic, paper, polyethylene, polypropylene, or the like. The first layer of material (10) and the second layer of material (11) can be sufficiently smooth to allow slidable engagement, as further described below.

As to particular embodiments, the first layer of material (10) and the second layer of material (11) of the first pocket (6) and the second pocket (8) can be joined separate from the garment (2) and then joined to the garment (2) at the first location (7) or the second location (9). As to particular embodiments, the first pocket (6) and the second pocket (8) can be removably joined to the garment (2) at the first location (7) or the second location (9) by mechanical fasteners (31) such as snaps, hooks, matable hook and loop fabric, or the like.

As to other particular embodiments, the first layer of material (10) of each of the first pocket (6) and the second pocket (8) can be a portion of the garment (2) and the second layer of material (11) for each of the first pocket (6) and the second pocket (8) can comprise a separate piece of material laid upon the garment (2). The piece of material laid upon the garment (2) can be joined to the garment (2) to provide the closed perimeter (12) to form the inside space (13) within the first pocket (6) and the second pocket (8).

As to other particular embodiments, the first layer of material (10) or the second layer of material (11) or both can be included in the garment (2). For example, a portion of the garment (2) may fold upon itself to provide the first layer of material (10) and the second layer of material (11). A part of the overlaid portion of the folded garment (2) can be joined to provide the closed perimeter (12) to form the first pocket (6) and the second pocket (8).

As to any of the above embodiments, a liner material (32) can be coupled in abutted relation to either or both of the first layer of material (10) or the second layer of material (11) such that the liner material (32) has a location between the first layer of material (10) and the second layer of material (11). The liner material (32) can be sufficiently smooth to allow movement of the corresponding first pocket (6) or the second pocket (8) in relation to the corresponding first catch part (29) or the second catch part (30) without magnetically uncoupling the first catch part (29) from the second catch part (30), thereby allowing adjustment of said garment (2).

Understandably, there is a numerous and wide variety of methods to form the first pocket (6) at the first location (7) on the garment (2) and to form the second pocket (8) at the second location (9) on the garment (2) and the above examples are intended to be sufficient for a person of ordinary skill in the art to make and use the numerous and varied embodiments of the invention.

FIGS. 1 through 4 provide generic example of the invention including a first elongate pocket (14) and a second elongate pocket (15) having a substantially rectangular closed perimeter (16) which defines and elongate rectangular inside space (17) (see for example FIG. 4). The rectangular inside space (17) as to certain embodiments can have a length in the range of about 3 inches and about 30 inches and width in the range of about one half inch and about one inch; although particular embodiments may have greater or lesser dimensional relations. The first location (7) and the second location (9) can be located proximate a garment edge (18). The external faces (20)(21) of the corresponding first elongate pocket (14) and the second elongate pocket (15) can be disposed in opposed relation.

Now referring primarily to FIGS. 2 and 4, a first magnet (22) can be located within the inside space (13) (elongate rectangular inside space (17)) of the first pocket (6) (first elongate pocket (14)) and a second magnet (23) can be located within the inside space (13) (elongate rectangular inside space (17)) of the second pocket (8) (second elongate pocket (15)). The first magnet (22) or the second magnet (23) can have a fixed location within the inside space (13)(17) of a corresponding first pocket (6)(14) or a second pocket (8)(15) while the other one of the first or second magnets (22)(23) can move freely within the corresponding first pocket (6)(14) or second pocket (8)(15). As to certain embodiments of the invention as illustrated in FIGS. 1 through 4, both the first magnet (22) and the second magnet (23) can move freely within the corresponding inside space (13)(17) of the first pocket (6)(14) and the second pocket (8)(15). As to certain embodiments, only a first magnet (22) located within the inside space (13) of a first pocket (6) may be provided while a ferromagnetic material (24) can be provided in the inside space (13) of a second pocket (8)(15).

The first magnet (22) and the second magnet (23) (or the ferromagnetic material (24)) can have any configuration suitable for location within the inside space (13) of the corresponding first pocket (6) and second pocket (8). As to the non-limiting example shown by FIGS. 1 through 4, each of the first magnet (22) and the second magnet (23) has the form of cylinder with a diameter in the range of about one quarter inch and about one half inch and height in the range of about one sixteenth inch and about one eighth inch.

Now referring primarily to FIG. 1, a particular method of using a particular embodiment of the magnetic catch (1) is shown in which the magnetic field (25) of the first magnet (22) and the second magnet (23) can be sufficient upon disposing the external faces (20)(21) of the first pocket (6)(14) and the second pocket (8)(15) in opposed relation to become sufficiently magnetically engaged to maintain the external faces (20)(21) of the first pocket (6)(14) and the second pocket (8)(15) in magnetic catched relation. Accordingly, the corresponding portions of the garment (2) can be maintained in releasably fixed relation by the magnetic catched relation of the external surfaces (3) (4) of the first pocket (6)(14) and the second pocket (8)(15).

Forcible urging upon the garment (2) in a first direction (26) can generate travel of the first magnet (22) or the second magnet (23) in the corresponding inside space (13)(17) of the first pocket (6)(14) or the second pocket (8)(15), or both of the first and second pockets (6)(7), to allow adjustment of the mated portions of the garment (2) or allow adjustment of the garment (2) in relation to the wearer (27) without releasing the magnetic catched relation of the first magnet (22) to the second magnet (23) (or the ferromagnetic material (24)). Similarly, forcible urging upon the garment (2) in a second direction (28) can generate travel of the first magnet (22) or the second magnet (23) in the corresponding inside space (13)(17) of the first pocket (6)(14) or the second pocket (8)(15), or both of the first and second pockets (6)(7), to allow adjustment of the mated portions of the garment (2) or allow adjustment of the garment (2) in relation to the wearer (27) without releasing the magnetic catched relation of the first magnet (22) to the second magnet (23) (or the ferromagnetic material (24)).

The magnetic catched relation of the first magnet (22) from the second magnet (23) (or the from the ferromagnetic material (24)) can be magnetically uncoupled by forcibly urging of the first magnet (22) away from the second magnet (23).

As can be easily understood from the foregoing, the basic concepts of the present invention may be embodied in a variety of ways. The invention involves numerous and varied embodiments of a magnetic catch and methods for making and using such magnetic catch including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “magnetic catch” should be understood to encompass disclosure of the act of “magnetically catching”—whether explicitly discussed or not—and, conversely, were there effectively disclosure of the act of “magnetically catching”, such a disclosure should be understood to encompass disclosure of a “magnetic catch” and even a “means for magnetically catching,” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric, values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the magnetic catches herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1-13. (canceled)

14. A method of producing a slidably adjustable magnetic catch for a garment, comprising the steps of:
a) providing a first pocket having a first location on a garment;
b) providing a magnetic catch having a first catch part and a second catch part;
c) enclosing said first catch part inside of said first pocket; and
d) coupling said second catch part at a second location on said garment, said first location and said second location on said garment allowing magnetic coupling of said first and second catch parts, and wherein said first catch part slides within said first pocket to allow movement of said first pocket in relation to said second catch part without magnetically uncoupling said first and second catch parts.

15. The method of producing a slidably adjustable magnetic catch for a garment of claim 14, further comprising the step of providing a second pocket; and enclosing said second catch part inside of said second pocket, said second catch part sliding within said second pocket to allow movement of said second pocket in relation to said first catch part.

16. The method of producing a slidably adjustable magnetic catch for a garment of claim 14, wherein said first catch part comprises a magnet or a ferromagnetic material.

17. The method of producing a slidably adjustable magnetic catch for a garment of claim 14, wherein said second catch part comprises a magnet or a ferromagnetic material.

18. The method of producing a slidably adjustable magnetic catch for a garment of claim 14, wherein said first pocket comprises a first layer of material overlaying a second layer of material joined to provide a closed perimeter enclosing an inside space.

19. The method of producing a slidably adjustable magnetic catch for a garment of claim 18, further comprising the step of removably coupling said first pocket to said first location on said garment.

20. The method of producing a slidably adjustable magnetic catch for a garment of claim 14, wherein said first pocket comprises a first layer of material overlaying a second layer of material joined to provide a closed perimeter enclosing an inside space, said first catch part having a location within said inside space, said first layer of material and said second layer of material formed by folding a part of said garment.

21. The method of producing a slidably adjustable magnetic catch for a garment of claim 18, further comprising the step of coupling a liner material coupled to said first layer of material and between said first layer of material and said second layer of material of said first pocket, said liner material sufficiently smooth to allow movement of said first pocket in relation to said second catch part without magnetically uncoupling said first and second catch parts, thereby allowing adjustment of said garment.

22. The method of producing a slidably adjustable magnetic catch for a garment of claim 15, wherein said first pocket or said second pocket comprises a first elongate pocket or a second elongate pocket which allows substantial movement of said first pocket or said second pocket in relation to said first catch part magnetically coupled to said second catch part.

23. The method of producing a slidably adjustable magnetic catch for a garment of claim 22, wherein said first pocket or said second pocket have a substantially rectangular closed perimeter which defines a first or second pocket having a width of between about one half inch and about one inch and a length of between about two inches to about thirty inches.

24. The method of using a magnetic catch for a garment, comprising the steps of:
a) magnetically coupling a first catch part to a second catch part, said first catch part enclosed inside of a first pocket having a first location on said garment, said second catch part coupled at a second location on said garment, and wherein said first catch part slides within said first pocket; and
b) moving said first pocket in relation to said magnetic catch without magnetically uncoupling said first catch part and second catch part to adjust said garment.

25. The method of using a magnetic catch for a garment of claim 24 wherein said step of magnetically coupling a first catch part to a second catch comprises magnetically coupling a first catch part to a second catch part, said first catch part enclosed inside of a first pocket having a first location on said garment, said second catch part enclosed inside of a second pocket having a second location on said garment, and wherein said first catch part slides within said first pocket and said second catch part slides within said second pocket.

26. The method of using a magnetic catch for a garment of claim 25, further comprising moving said second pocket in relation to said magnetic catch without magnetically uncoupling said first catch part and second catch part to adjust said garment.

27. The method of using a magnetic catch for a garment of claim 24, further comprising the step of magnetically uncoupling said first catch part from said second catch part, said first catch part remaining inside of said first pocket, said second catch part remaining coupled to said garment.

28. The method of using a magnetic catch for a garment of claim 24, further comprising the step of engaging said garment to a part of the body of an animal.

29. The method of using a magnetic catch for a garment of claim 28, further comprising the step of disengaging said garment from a part of the body of an animal.
